(19) United States
(12) Patent Application Publication
(10) Pub. No.: US 2026/0062616 A1
(43) Pub. Date: Mar. 5, 2026

(54) LIQUID CRYSTAL COMPOSITION AND LIQUID CRYSTAL OPTICAL ELEMENT CONTAINING SAME

(71) Applicant: Nanchang Virtual Reality Research Institute Co., Ltd., Nanchang (CN)

(72) Inventors: Mingli Ni, Nanchang (CN); Feng Ma, Nanchang (CN); Weiming He, Nanchang (CN); Zhenlin Yan, Nanchang (CN); Junxing Yang, Nanchang (CN)

(21) Appl. No.: 19/284,946

(22) Filed: Jul. 30, 2025

Related U.S. Application Data
(63) Continuation of application No. PCT/CN2024/143993, filed on Dec. 30, 2024.

(30) Foreign Application Priority Data
Sep. 2, 2024 (CN) 202411222806.5

(51) Int. Cl. C09K 19/20; C09K 19/12

(52) U.S. Cl. CPC C09K 19/20; C09K 19/12; C09K 2019/123; C09K 2019/124; C09K 2019/2035; C09K 2019/2078

(57) ABSTRACT

The present application provides a liquid crystal composition and a liquid crystal optical element containing the same, where the liquid crystal composition includes at least one compound of formula I, at least one compound of formula II, at least one compound of formula III, and/or at least one compound of formula IV. The liquid crystal composition may further include a chiral agent and a photosensitizer. The present invention further provides a liquid crystal optical element including the liquid crystal composition of the present invention. By using the liquid crystal composition of the present invention to fabricate a liquid crystal optical element, the difficulty of the fabrication process for a polymerizable cholesteric liquid crystal optical element can be reduced, and the diffraction efficiency of the optical element can be improved.

### CROSS-REFERENCE TO RELATED APPLICATIONS

The present application is a continuation application of PCT application No. PCT/CN2024/143993 filed on Dec. 30, 2024, which claims the benefit of Chinese Patent Application No. 202411222806.5 filed on Sep. 2, 2024. The contents of all of the aforementioned applications are incorporated by reference herein in their entirety.

### TECHNICAL FIELD

The present application pertains to the field of liquid crystal display materials, and specifically relates to a liquid crystal composition and a liquid crystal optical element containing the same.

### BACKGROUND

Liquid crystals (LC), as an anisotropic optical material, can introduce phase retardation to polarized light, making liquid crystals (LC) an important material for preparing wave plates (or phase retarders). Passive (LC polymer) optical elements can be manufactured from polymerizable liquid crystals. Passive LC wave plates are polymer films stabilized by UV treatment, characterized by ultra-thinness and lightweight. Holographic optical elements (HOE) made from holographic polymers made of polymerizable cholesteric liquid crystals can achieve compactness and lightweight design for near-eye display modules.

Currently, polymerizable liquid crystals are primarily studied using a single type of liquid crystal monomer. These studies encompass off-axis lenses, liquid crystal gratings, phase modulation, and other areas, but are not limited to these research and applications. In these studies and applications, a liquid crystal monomer, a chiral agent, a photosensitizer, or another additive such as co-initiator, antioxidant, or UV stabilizer are mixed at a specific ratio. These components are mixed by heating or using a solvent, and then applied onto a glass substrate, wafer, or plastic substrate through blade coating or spin coating. Exposure is performed as needed to obtain a target optical element. In fabricating a liquid crystal optical element using only one liquid crystal monomer, only a flexible liquid crystal monomer molecule with low birefringence and low phase transition temperature can be selected to ensure feasibility in the fabrication process. Choosing an inappropriate molecule causes rapid crystallization of the molecule after coating, compromising the designed functionality. In terms of performance, birefringence can directly determine a reflection wavelength bandwidth of a polymerized liquid crystal grating or off-axis lenses, with higher birefringence resulting in a wider reflection wavelength bandwidth. Using one liquid crystal monomer makes it difficult to satisfy both fabrication feasibility and performance enhancement. The commonly used liquid crystal monomer for research and production of liquid crystal optical elements is RM257, which barely meets the requirements for experimental fabrication and functional performance. The structural formula of RM257 is as follows:

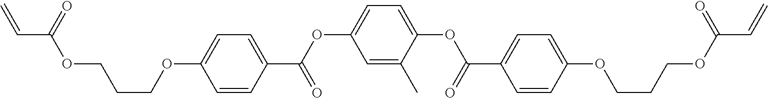 [SMILES: C=CC(=O)OCCCOc1ccc(C(=O)Oc2ccc(OC(=O)c3ccc(OCCCOC(=O)C=C)cc3)c(C)c2)cc1]

### SUMMARY

It is difficult for one liquid crystal monomer to meet both fabrication feasibility and performance enhancement in the prior art. To address the issue, the present invention provides a liquid crystal composition that can reduce the difficulty of the fabrication process for polymerizable cholesteric liquid crystal optical elements and improve the diffraction efficiency of the optical elements.

According to a first aspect, an embodiment of the present application provides a liquid crystal composition, including:

The liquid crystal composition includes at least one compound of formula I, at least one compound of formula II, at least one compound of formula III, and/or at least one compound of formula IV:
at least one compound of formula I

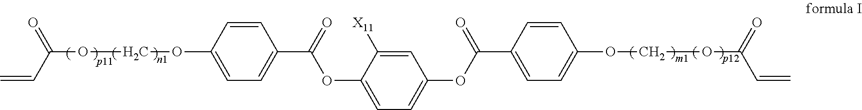

at least one compound of formula II

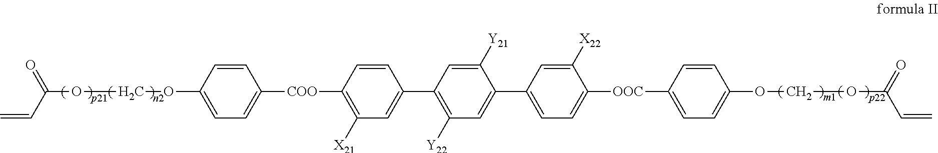

at least one compound of formula III

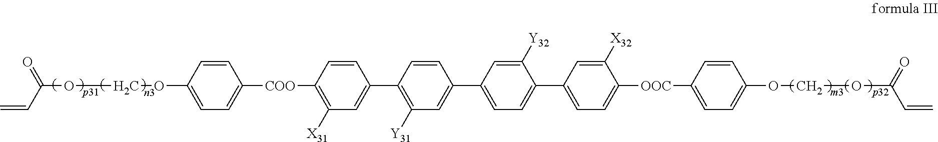

at least one compound of formula IV

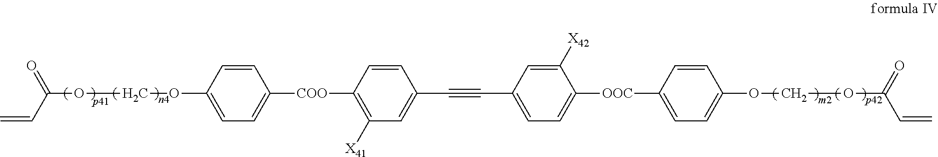

where n1, n2, m1, m2, n3, m3, n4, and m4 each independently represent 0, 1, 2, 3, 4, 5, 6, 7, 8, 9, or 10; when n1, n2, m1, m2, n3, m3, n4, and m4 each represent 0, p11, p12, p21, and p22 each represent 0, and when n1, n2, m1, and m2 are each not 0, p11, p12, p21, p22, p31, p32, p41, and p42 each represent 1; and X11, X21, X22, Y21, Y22, X31, X32, Y31, Y32, X41, and X42 each independently represent H, F, CH3, Cl, or Br; and
based on a total weight of the liquid crystal composition, a weight percentage of the compound of formula I is 10%-90%, a weight percentage of the compound of formula II is 1%-70%, a weight percentage of the compound of formula III is 1%-70%, and a weight percentage of the compound of formula IV is 1%-60%.

In another embodiment of the present application, the compound of formula I has the following structural formula:

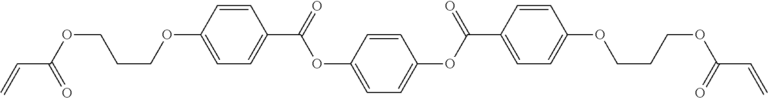 [SMILES: C=CC(=O)OCCCOc1ccc(C(=O)Oc2ccc(OC(=O)c3ccc(OCCCOC(=O)C=C)cc3)cc2)cc1]

In another embodiment of the present application, the compound of formula II has the following structural formula:

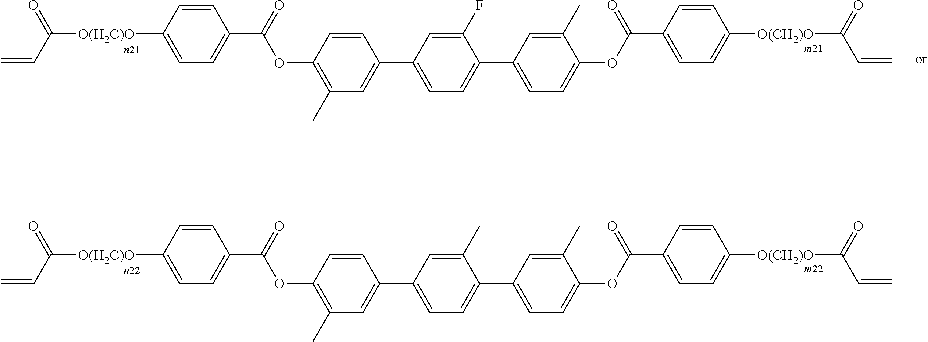

where n21, n22, m21, and m22 each independently represent 1, 2, 3, 4, 5, 6, 7, 8, 9, or 10.

In another embodiment of the present application, the compound of formula III has the following structural formula:

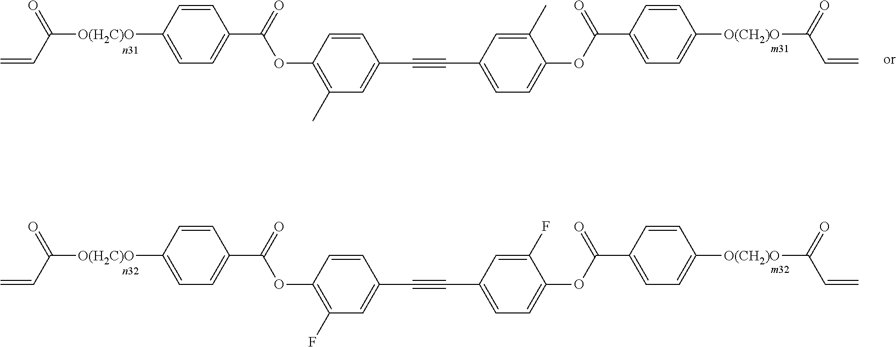

where n31, n32, m31, and m32 each independently represent 1, 2, 3, 4, 5, 6, 7, 8, 9, or 10.

In another embodiment of the present application, the compound of formula IV has the following structural formula:

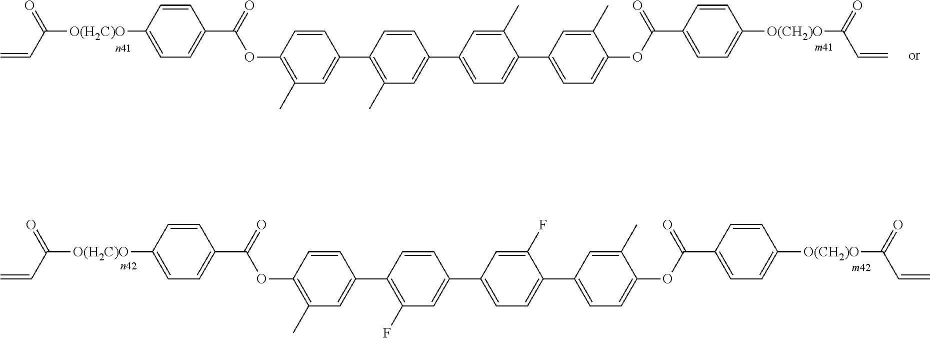

where n41, n42, m41, and m42 each independently represent 1, 2, 3, 4, 5, 6, 7, 8, 9, or 10.

In another embodiment of the present application, the compound of formula I, the compound of formula II, the compound of formula III, and the compound of formula IV are combined at a specific weight ratio to form the liquid crystal composition.

In another embodiment of the present application, the weight percentage of the compound of formula I is 10%-80%, the weight percentage of the compound of formula II is 1%-60%, the weight percentage of the compound of formula III is 1%-60%, and the weight percentage of the compound of formula IV is 1%-50%.

In another embodiment of the present application, the weight percentage of the compound of formula I is 10%-70%, the weight percentage of the compound of formula II is 1%-50%, the weight percentage of the compound of formula III is 1%-50%, and the weight percentage of the compound of formula IV is 1%-40%.

In another embodiment of the present application, in addition to the compound of formula I, the compound of formula II, the compound of formula III, and the compound of formula IV, the liquid crystal composition further includes a chiral agent or a photosensitizer; and the chiral agent can be a right-handed chiral agent or a left-handed chiral agent. For example, the chiral agent is selected from one or more of S811, S5011, S2011, R811, R5011, and R2011, enabling the composition to transition from a nematic liquid crystal phase to a cholesteric liquid crystal phase with a specific reflection wavelength. The photosensitizer is selected from one or more of UV651, TPO, and rose bengal.

In the present application, the chemical names or structural formulas corresponding to the chiral agents used are shown in Table 1:

TABLE 1

| Name | Chemical name | Structural formula |
|---|---|---|
| S5011 | (13BS)-5,6- dihydro-5-(trans-4- propylcyclo- hexyl)-4H- dinaphtho[2,1-F:1′,2′-H]] [1,5]dioxacyclo- nonatetraene | 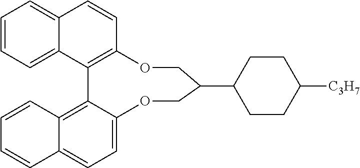 |
| S811 | 4-(4-hexyloxy- benzoyloxy)benzoic acid S-(+)-2-octyl ester | 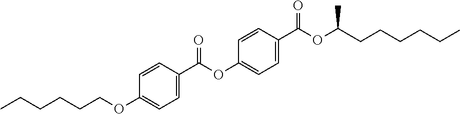 [SMILES: CCCCCCOc1ccc(C(=O)Oc2ccc(C(=O)O[C@@H](C)CCCCCC)cc2)cc1] |
| S2011 | [4(S)-[trans(trans)]]]]- 1,3-difluoro-2- [(1-methylheptyl) oxy]-5-(4′- propyl[1,1′- bicyclohexyl]-4- yl)benzene | 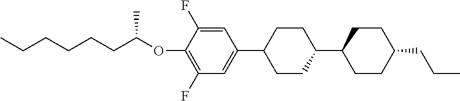 |
| R811 | 4-(4-hexyloxy- benzoyloxy)benzoic acid R-(+)-2-octyl ester | 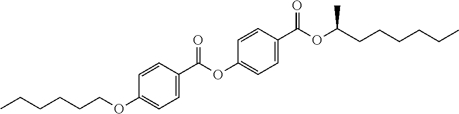 [SMILES: CCCCCCOc1ccc(C(=O)Oc2ccc(C(=O)O[C@@H](C)CCCCCC)cc2)cc1] |
| R5011 | (13BR)-5,6- dihydro-5-(trans-4- propylcyclohexyl)-4H- dinaphtho [2,1-F:1′,2′-H] [1,5]dioxacyclo- nonatetraene | 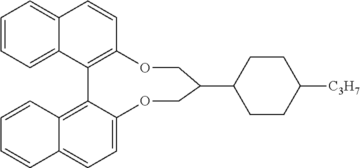 |
| R2011 | [4(R)-[trans(trans)]]- 1,3-difluoro-2- [[(1-methylheptyl) oxy]-5-(4′- propyl[1,1′- bicyclohexane]-4- yl)benzene | 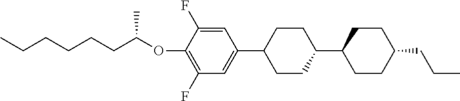 |

In the present application, the chemical names or structural formulas corresponding to the photosensitizers used are shown in Table 2:

TABLE 2

| Name | Chemical name | Structural formula |
|---|---|---|
| UV651 | 2,2-dimethoxy-2- phenylacetophenone | 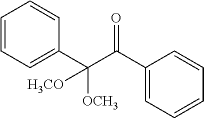 [SMILES: COC(OC)(C(=O)c1ccccc1)c1ccccc1] |
| TPO | 2,4,6-trimethylbenzoyl- diphenylphosphine oxide | 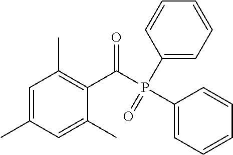 [SMILES: Cc1cc(C)c(C(=O)P(=O)(c2ccccc2)c2ccccc2)c(C)c1] |
| Rose bengal | 2,3,4,5-tetrachloro-6-[2,4,5,7- tetraiodo-6-oxo-3-oxo-3H- xanthen-9-yl]benzoic acid | 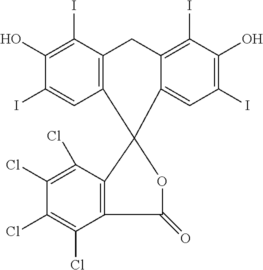 [SMILES: O=C1OC2(c3cc(I)c(O)c(I)c3Cc3c2cc(I)c(O)c3I)c2c(Cl)c(Cl)c(Cl)c(Cl)c21] |

According to a second aspect, the present application further provides a planar optical device, a polymerizable liquid crystal material used in the optical device, and a preparation method of the optical device.

The present application has the following beneficial effects:

1. Compared to the prior art, the present invention reduces the phase transition temperature from the crystalline to the liquid crystal phase of the liquid crystal composition material, and during the process of fabricating a liquid crystal optical element, can allow the liquid crystal composition material to consistently maintain the liquid crystal phase, so as to form an optical element with a complete cholesteric liquid crystal film after final exposure.

2. Maintaining the liquid crystal phase during the process improves the film-forming properties of the liquid crystal material during optical element fabrication, resulting in more uniform films after formation and higher consistency in diffraction efficiency.

3. The liquid crystal composition of the present invention has high birefringence, enabling grating elements fabricated using the liquid crystal composition of the present invention to achieve higher diffraction efficiency.

### DESCRIPTION OF EMBODIMENTS

To enable those skilled in the art to better understand the technical solutions of the present application, the technical solutions in the embodiments of the present application will be described clearly and completely below. It is apparent that the described embodiments are only a part of the embodiments of the present application, rather than all embodiments. Based on the embodiments in the present application, all other embodiments obtained by those of ordinary skill in the art without making creative efforts shall fall within the scope of protection of the present application. In the following embodiments, unless otherwise specified, the specific conditions of the test methods are generally implemented according to conventional conditions or conditions recommended by the manufacturer. Raw materials and reagents are obtained commercially or prepared using publicly available information.

Preparation of liquid crystal material: Compounds represented by formula I, formula II, formula III, and formula IV are weighed according to percentages using an electronic balance, where the compounds represented by formula I, formula II, formula III, and formula IV are weighed according to weight percentages. The weighed liquid crystal composition is uniformly mixed by heating, or dichloromethane is used as a solvent to mix with the liquid crystal composition, where the volume ratio of the dichloromethane to the liquid crystal composition is 4:1 to 10:1.

A photosensitizer, such as UV651 or TPO, is added at a weight percentage of 0.1%-2%, and a chiral agent with a corresponding wavelength is added, whose content is calculated according to the formula:

$$λ = \overline{n} p , HTP = ( pc ) - 1 P = \frac{1}{c \cdot HTP} , \overline{n} = \sqrt[2]{\frac{{n}_{e}^{2} + 2 {n}_{o}^{2}}{3} ,} λ = \overline{n} P$$

where λ represents the response wavelength, n̅ represents the average refractive index of the liquid crystal, p represents the pitch of the liquid crystal, c represents the concentration of the chiral agent, and HTP represents the helical twisting power constant.

Tables 3 and 4 list the formulations of the liquid crystal compositions in different embodiments.

TABLE 3

| | | Weight percentage of each component relative to | | | | |
|---|---|---|---|---|---|---|
| | | total weight of liquid crystal composition | | | | |
| | | Compar- | Compar- | Compar- | Compar- | Compar- |
| | | ative | ative | ative | ative | ative |
| Com- | | Exam- | Exam- | Exam- | Exam- | Exam- |
| ponent | Liquid crystal monomer | ple 1 | ple 2 | ple 3 | ple 4 | ple 5 |
| Formula I | 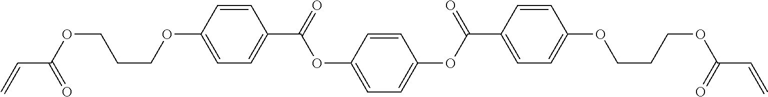 [SMILES: C=CC(=O)OCCCOc1ccc(C(=O)Oc2ccc(OC(=O)c3ccc(OCCCOC(=O)C=C)cc3)cc2)cc1] | 100 | 55 | 45 | 60 | 50 |
| Formula II | 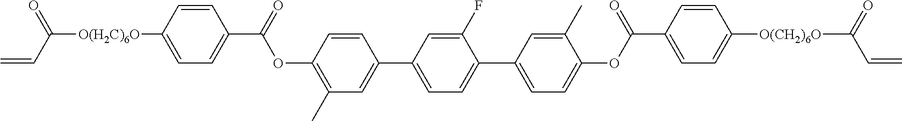 | | 10 | 10 | 10 | |
| | 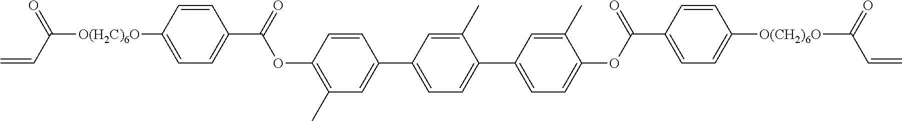 | | 15 | 10 | | |
| | 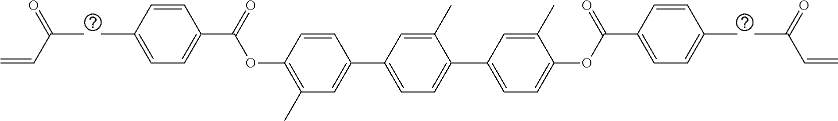 [symbol] | | 10 | 15 | | |
| | 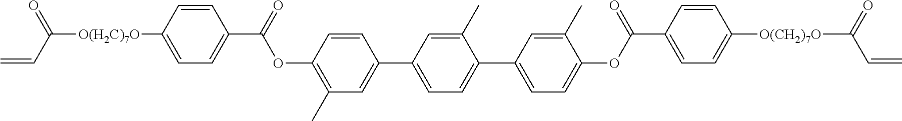 | | 10 | 10 | | |
| Formula III | 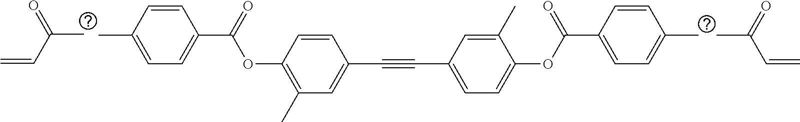 | | | | 10 | 10 |
| | 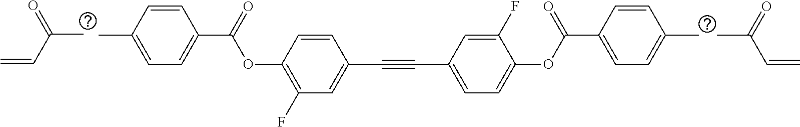 | | | | 10 | 10 |
| | 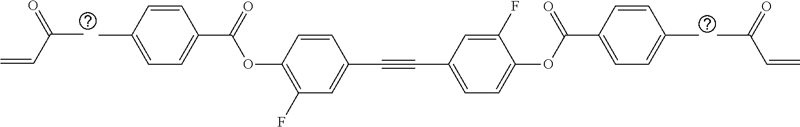 | | | | 10 | 10 |
| | 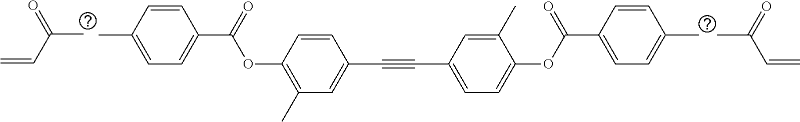 | | | | 10 | 10 |
| Formula IV | 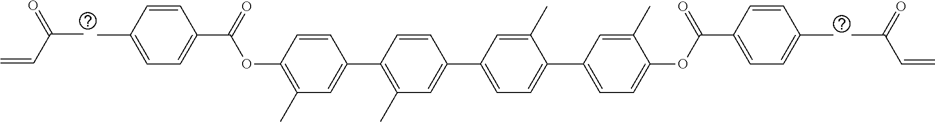 | | | 10 | | |
| | 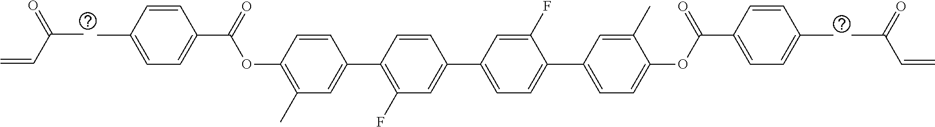 | | | 10 | | 10 |
| | 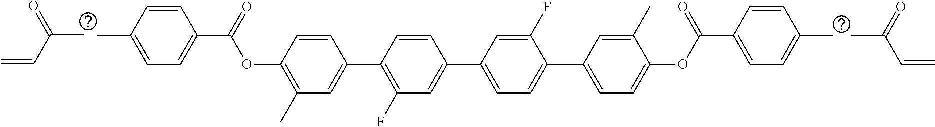 | | | | | |
| Chiral | S5011 | 2.06 | 2.44 | 3.44 | 2.30 | 2.40 |
| agent | | | | | | |
| Photo- | TPO | 1 | 1 | 1 | 1 | 1 |
| sensitizer | | | | | | |

[symbol]

indicates data missing or illegible when filed

TABLE 4

| | | Weight percentage of each | | | | |
|---|---|---|---|---|---|---|
| | | component relative to total weight | | | | |
| | | of liquid crystal composition | | | | |
| Com- | | Exam- | Exam- | Exam- | Exam- | Exam- |
| ponent | Liquid crystal monomer | ple 1 | ple 2 | ple 3 | ple 4 | ple 5 |
| Formula I | 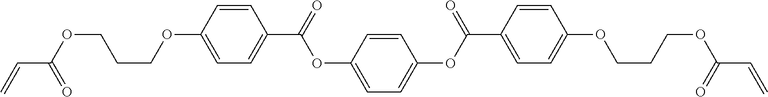 [SMILES: C=CC(=O)OCCCOc1ccc(C(=O)Oc2ccc(OC(=O)c3ccc(OCCCOC(=O)C=C)cc3)cc2)cc1] | 40 | 40 | 45 | 45 | 50 |
| Formula II | 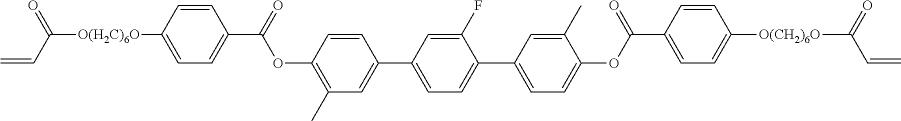 | 10 | | | | 5 |
| | 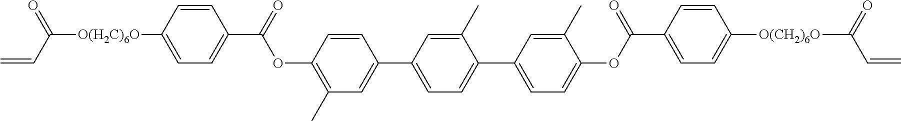 | 10 | | 10 | 10 | 5 |
| | 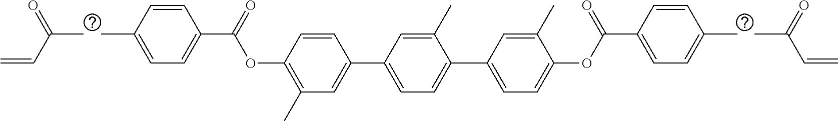 [symbol] | | 10 | 5 | | 5 |
| | 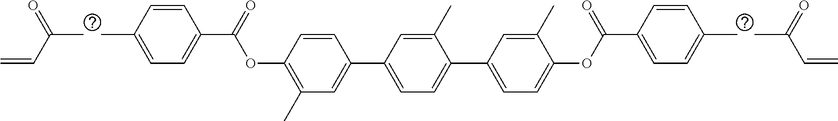 | | 10 | | 10 | 5 |
| Formula III | 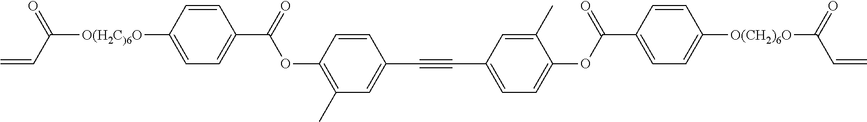 | 10 | | | 10 | |
| | 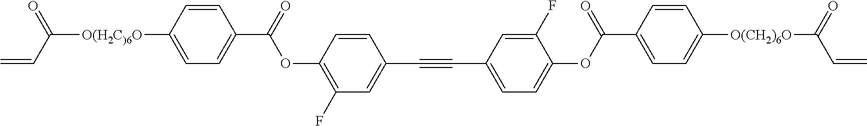 | 10 | | 10 | | 10 |
| | 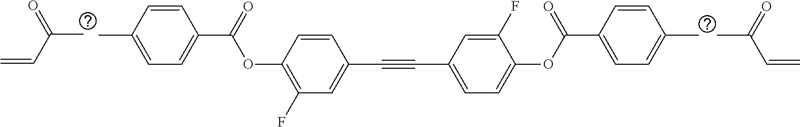 | | 10 | | 10 | 10 |
| | 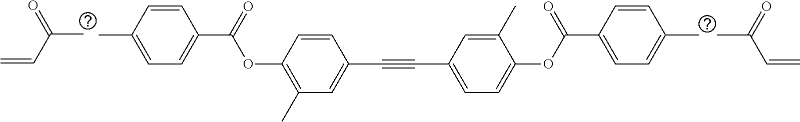 | | 10 | | 10 | |
| Formula IV | 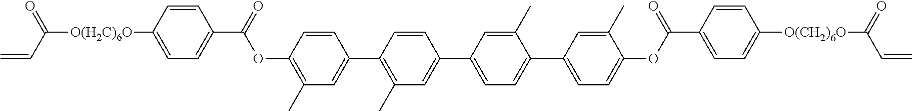 | | 10 | 5 | 10 | |
| | 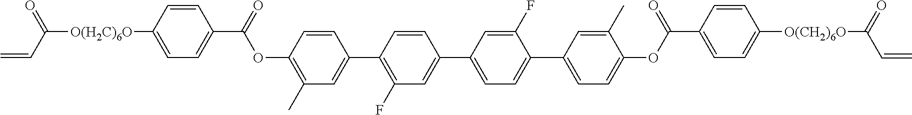 | 10 | 10 | 10 | | 5 |
| | 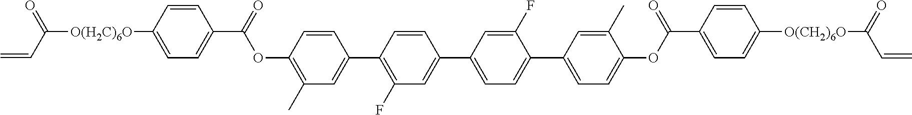 | 10 | | | 5 | 5 |
| Chiral | S5011 | 3.11 | 3.08 | 2.89 | 2.87 | 2.78 |
| agent | | | | | | |
| Photo- | TPO | 1 | 1 | 1 | 1 | 1 |
| sensitizer | | | | | | |

[symbol]

indicates data missing or illegible when filed

TABLE 5

| | | Weight percentage of each | | | | |
|---|---|---|---|---|---|---|
| | | component relative to total weight | | | | |
| | | of liquid crystal composition | | | | |
| Com- | | Exam- | Exam- | Exam- | Exam- | Exam- |
| ponent | Liquid crystal monomer | ple 6 | ple 7 | ple 8 | ple 9 | ple 10 |
| Formula I | 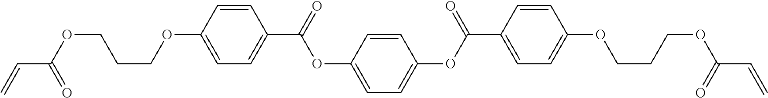 [SMILES: C=CC(=O)OCCCOc1ccc(C(=O)Oc2ccc(OC(=O)c3ccc(OCCCOC(=O)C=C)cc3)cc2)cc1] | 50 | 55 | 55 | 60 | 60 |
| Formula II | 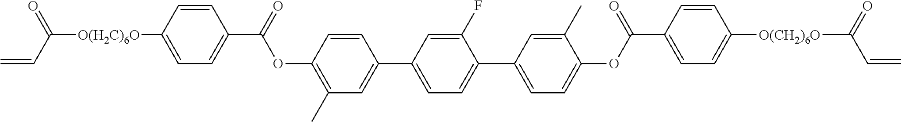 | 10 | | 10 | | 5 |
| | 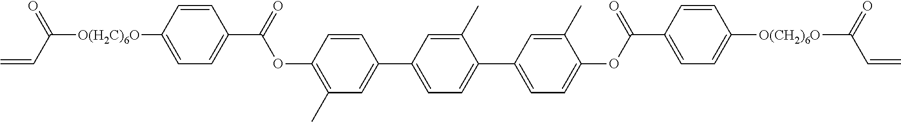 | | 10 | | | 5 |
| | 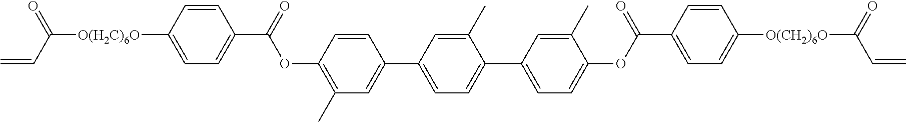 | | 10 | | 5 | |
| | 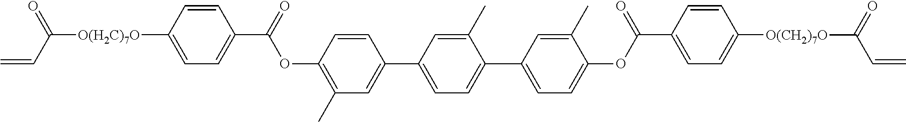 | 10 | | 10 | 5 | |
| Formula III | 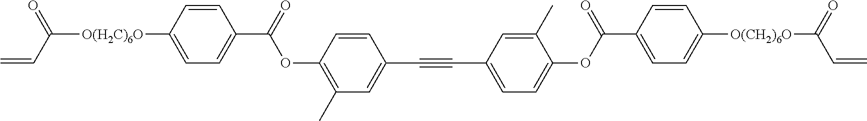 | 5 | 5 | | 5 | 5 |
| | 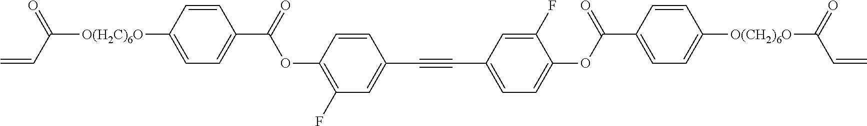 | 5 | | 5 | 5 | 5 |
| | 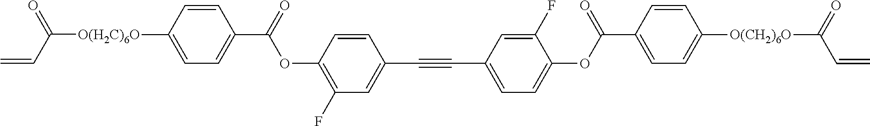 | 5 | 5 | | 5 | 5 |
| | 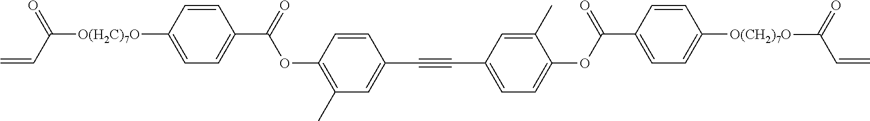 | 5 | | 5 | 5 | 5 |
| Formula IV | 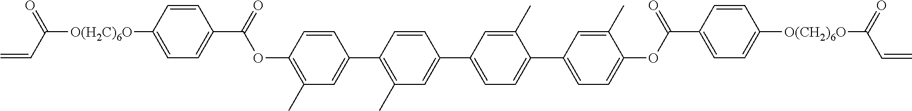 | 5 | 5 | 5 | 5 | |
| | 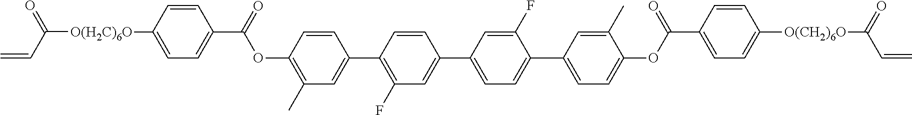 | 5 | 5 | 5 | 5 | 5 |
| | 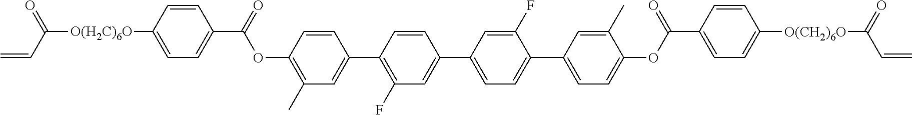 | | 5 | 5 | | 5 |
| Chiral | S5011 | 2.30 | 2.50 | 2.50 | 2.42 | 2.42 |
| agent | | | | | | |
| Photo- | TPO | 1 | 1 | 1 | 1 | 1 |
| sensitizer | | | | | | |

The components of the liquid crystal composition provided by the present application consist of four components represented by four general formulas, and the optimal performance of the composition includes compounds represented by formula I, formula II, formula III, and formula IV. A composition formed by pairwise mixing or individually mixing the compounds represented by formula II, formula III, and formula IV with the compound represented by formula I also show performance improvement. The composition obtained from the compounds represented by formula III and formula IV and the compound represented by formula I exhibits the greatest improvement in the key parameter of birefringence Δn, but the phase transition temperature is also relatively high, posing significant challenges in industrial production. The composition obtained from the compound represented by formula II and the compound represented by formula I shows a certain degree of improvement in birefringence Δn, but the phase transition temperature is also high, offering certain improvement in performance and industrial production. The composition formed by the compound represented by formula II and the compound represented by formula I, and the composition obtained from the compounds represented by formula III and formula IV, and the compound represented by formula I, both exhibit improved performance and reduced production difficulty as compared with using only the compound represented by formula I as the material. The composition obtained from the compounds represented by formula I, formula II, formula III, and formula IV is comprehensively evaluated as optimal in terms of performance and process production. (The difficulty of the production process is primarily determined by the phase transition temperature, higher phase transition temperature means more difficulty, and lower phase transition temperature means less difficulty. The parameters Ter and Ten mentioned below represent phase transition temperatures).

TABLE 6

| | Comparative | Comparative | Comparative | Comparative | Comparative | Example | Example |
|---|---|---|---|---|---|---|---|
| Parameter | Example 1 | Example 2 | Example 3 | Example 4 | Example 5 | 1 | 2 |
| d/μm | 1.5 | 1.5 | 1.5 | 1.5 | 1.5 | 1.5 | 1.5 |
| Δn | 0.153 | 0.177 | 0.180 | 0.175 | 0.176 | 0.181 | 0.181 |
| Tcr | 104 | Null | Null | Null | Null | Null | Null |
| Tcn | Null | 34 | 48 | 31 | 41 | 31 | 29 |
| η | 30% | 44% | 53% | 41% | 41% | 54% | 53% |

| | Example | Example | Example | Example | Example | Example | Example | Example |
|---|---|---|---|---|---|---|---|---|
| Parameter | 3 | 4 | 5 | 6 | 7 | 8 | 9 | 10 |
| d/μm | 1.5 | 1.5 | 1.5 | 1.5 | 1.5 | 1.5 | 1.5 | 1.5 |
| Δn | 0.180 | 0.180 | 0.178 | 0.178 | 0.177 | 0.177 | 0.175 | 0.175 |
| Tcr | Null | Null | Null | Null | Null | Null | Null | Null |
| Tcn | 24 | 24 | 21 | 19 | 14 | 16 | 8 | 7 |
| η | 52% | 53% | 47% | 47% | 45% | 43% | 41% | 40% |

In Table 6, Δn represents the liquid crystal birefringence, Ter represents the temperature at which the liquid crystal transitions from the crystalline phase to the liquid phase, Ton represents the temperature at which the liquid crystal transitions from the crystalline phase to the nematic phase, η represents the diffraction efficiency, and d represents the thickness of the liquid crystal film layer.

From Table 6, it can be seen that the phase transition temperature in the embodiments of the present application are close to or below room temperature, ensuring that the liquid crystal composition can maintain a cholesteric phase helical structure with intact optical properties for a longer period after spin coating. In contrast, in comparative examples using one liquid crystal monomer, crystallization occurs in a short time, losing the helical structure of the cholesteric phase and thus losing optical properties. When liquid crystal gratings of the same thickness are made from the comparative examples and embodiments, it can be evidently seen that the diffraction gratings of the embodiments show significant improvement.

According to a second aspect, the present application further provides a planar optical device, a polymerizable liquid crystal material used in the optical device, and a preparation method of the optical device.

Traditional cholesteric liquid crystal optical devices such as HOE and PVG use acrylate liquid crystal monomers with photopolymerization properties. For example, the liquid crystal monomer RM257 is commonly used in the academic field to prepare a dichloromethane solution for use as a liquid crystal optical material, or RM257 is mixed with some common polymerizable liquid crystals to form a composite liquid crystal composition, which can reduce the crystallization temperature of the liquid crystal material, but the refractive index of the liquid crystal material changes little or increases only slightly, resulting in limited improvement in the optical performance of the liquid crystal material. The liquid crystal composition of the present invention, composed of the compounds represented by formula I, formula II, formula III, and formula IV, not only increases the temperature range of the liquid crystal phase and reduces the crystallization temperature of the liquid crystal material, but also increases the key optical performance parameter of birefringence of the liquid crystal material. The increase in the birefringence of the liquid crystal material results in higher diffraction efficiency in optical devices such as HOE PVG fabricated from it.

A preparation method of an optical element includes the following steps:
preparing a first substrate, where the substrate can be a glass substrate or a plastic substrate, and applying an alignment layer on the substrate through spin coating or blade coating, where the alignment layer is bright yellow (bright yellow) or other materials that can be aligned by polarized visible light or UV light (commonly used alignment layer materials further include SD1, ATA0042, ATA2, or the like);
performing patterned alignment on the alignment layer according to a designed pattern by using a blue laser; and
applying a prepared liquid crystal composition or a mixture of a liquid crystal composition and dichloromethane onto the aligned substrate through blade coating or spin coating, and curing it using blue light or UV light to obtain an optical device.

The structural formula of bright yellow is as follows:

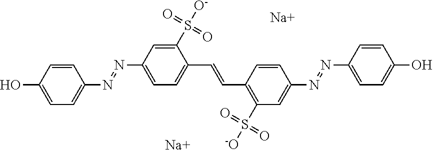

The structural formula of ATA0042 is as follows:

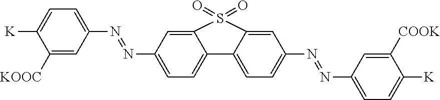

The structural formula of ATA2 is as follows:

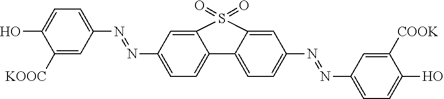

The structural formula of SD1 is as follows:

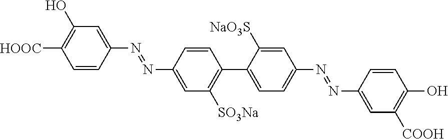

Finally, it should be noted that the above embodiments are only used to illustrate the technical solutions of the present application and not to limit them. Although the present application has been described in detail with reference to the foregoing embodiments, those of ordinary skill in the art should understand that they can still modify the technical solutions described in the foregoing embodiments or make equivalent replacements for some or all of the technical features. These modifications or replacements do not cause the essence of the corresponding technical solutions to depart from the scope of the technical solutions of the embodiments of the present application.

1. A liquid crystal composition, wherein the liquid crystal composition comprises at least one compound of formula I, at least one compound of formula II, at least one compound of formula III, and/or at least one compound of formula IV:
at least one compound of formula I 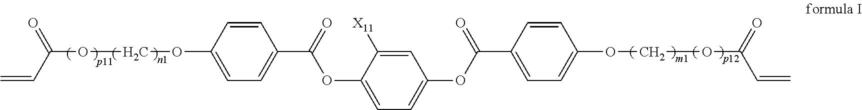
at least one compound of formula II 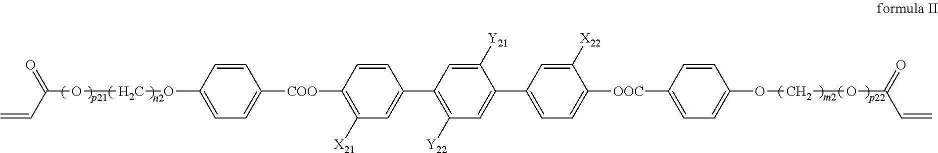
at least one compound of formula III 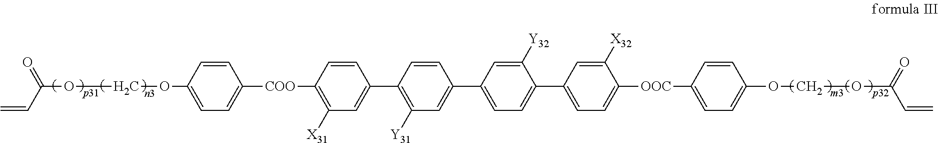
at least one compound of formula IV 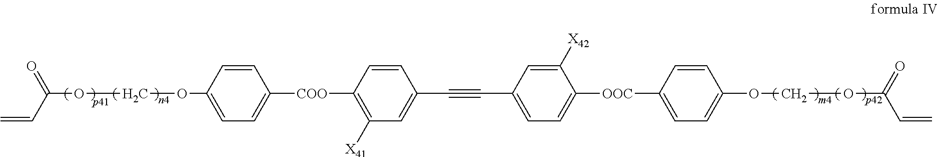
wherein n1, n2, m1, m2, n3, m3, n4, and m4 each independently represent 0, 1, 2, 3, 4, 5, 6, 7, 8, 9, or 10; when n1, n2, m1, m2, n3, m3, n4, and m4 each represent 0, p11, p12, p21, and p22 each represent 0, and when n1, n2, m1, and m2 are each not 0, p11, p12, p21, p22, p31, p32, p41, and p42 each represent 1; and X11, X21, X22, Y21, Y22, X31, X32, Y31, Y32, X41, and X42 each independently represent H, F, CH3, Cl, or Br; and
based on a total weight of the liquid crystal composition, a weight percentage of the compound of formula I is 10%-90%, a weight percentage of the compound of formula II is 1%-70%, a weight percentage of the compound of formula III is 1%-70%, and a weight percentage of the compound of formula IV is 1%-60%.

2. The liquid crystal composition according to claim 1, wherein the compound of formula I has the following structural formula:

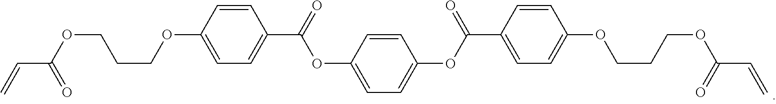 [SMILES: C=CC(=O)OCCCOc1ccc(C(=O)Oc2ccc(OC(=O)c3ccc(OCCCOC(=O)C=C)cc3)cc2)cc1]

3. The liquid crystal composition according to claim 1, wherein the compound of formula II has the following structural formula: 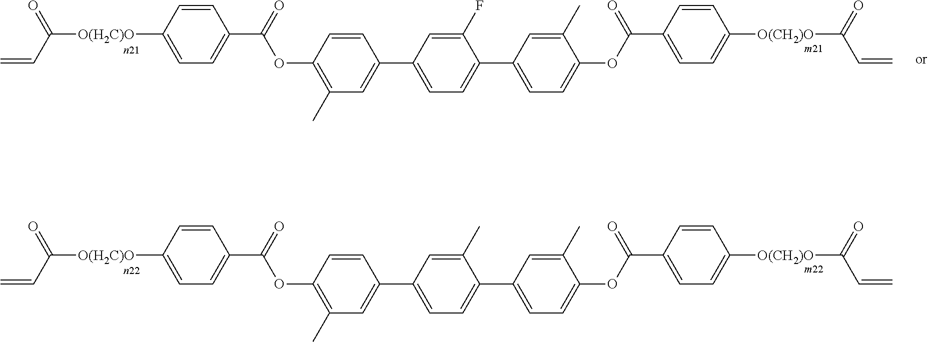
wherein n21, n22, m21, and m22 each independently represent 1, 2, 3, 4, 5, 6, 7, 8, 9, or 10.

4. The liquid crystal composition according to claim 1, wherein the compound of formula III has the following structural formula: 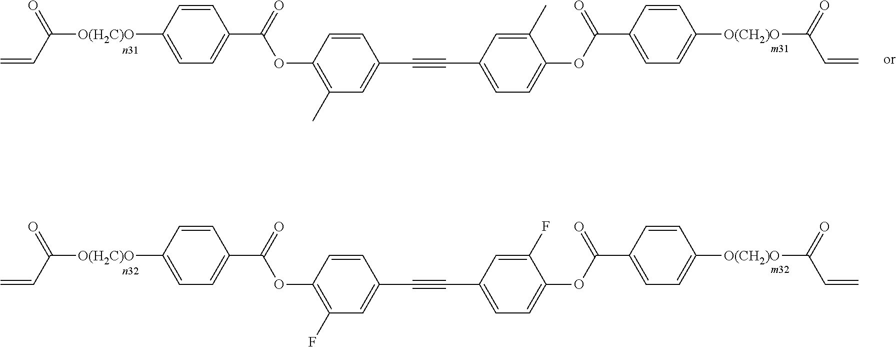
wherein n31, n32, m31, and m32 each independently represent 1, 2, 3, 4, 5, 6, 7, 8, 9, or 10.

5. The liquid crystal composition according to claim 1, wherein the compound of formula IV has the following structural formula: 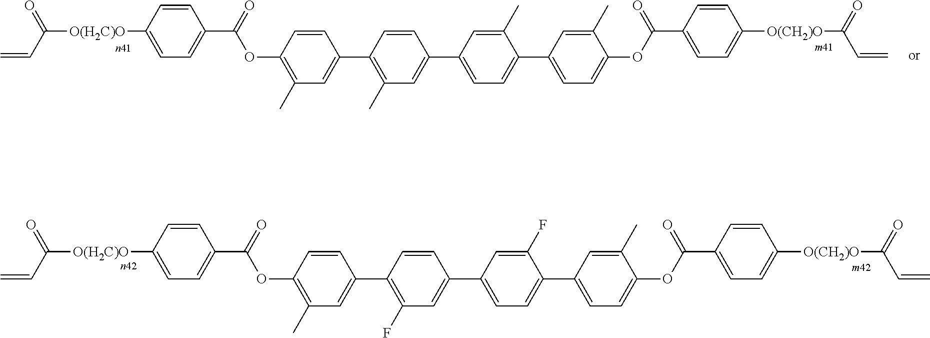
wherein n41, n42, m41, and m42 each independently represent 1, 2, 3, 4, 5, 6, 7, 8, 9, or 10.

6. The liquid crystal composition according to claim 1, wherein the weight percentage of the compound of formula I is 10%-80%, the weight percentage of the compound of formula II is 1%-60%, the weight percentage of the compound of formula III is 1%-60%, and the weight percentage of the compound of formula IV is 1%-50%.

7. The liquid crystal composition according to claim 1, wherein the liquid crystal composition further comprises a chiral agent or a photosensitizer.

8. The liquid crystal composition according to claim 7, wherein the chiral agent is selected from one or more of S811, S5011, S2011, R811, R5011, and R2011, and the photosensitizer is selected from one or more of UV651, TPO, and Rose Bengal.

9. A liquid crystal optical element, comprising the liquid crystal composition according to claim 1.
